(19) United States
(12) Patent Application Publication
(10) Pub. No.: US 2026/0073736 A1
(43) Pub. Date: Mar. 12, 2026

(54) PREDICTION DEVICE, PREDICTION METHOD, AND PREDICTION PROGRAM

(71) Applicant: ISUZU MOTORS LIMITED, Yokohama-shi (JP)

(72) Inventors: Yuri SAWAI, Fujisawa-shi (JP); Toshiyuki USUI, Fujisawa-shi (JP); Hironori ARAKI, Fujisawa-shi (JP); Kazuya SEKI, Fujisawa-shi (JP)

(21) Appl. No.: 19/256,518

(22) Filed: Jul. 1, 2025

(30) Foreign Application Priority Data
Sep. 9, 2024 (JP) 2024-154709

(51) Int. Cl. G07C 5/00; F16K 37/00; G07C 5/08

(52) U.S. Cl. CPC G07C 5/006; F16K 37/0083; F16K 37/0091; G07C 5/0808

(57) ABSTRACT

An object of the present disclosure is to provide a prediction device capable of predicting replacement required timing of an oil check valve mounted on a vehicle. A prediction device according to the present disclosure is for predicting replacement required timing of an oil check valve provided in an oil circulation path of a vehicle. The prediction device includes the following: an acquisition section that acquires, from a storage section, first information related to an operation history of the oil check valve and second information related to an oil temperature history of oil in the oil circulation path; and a calculation section that calculates an indicator related to the replacement required timing of the oil check valve based on the first information and the second information by using a classifier model that has been trained in advance.

### CROSS REFERENCE TO RELATED APPLICATIONS

This application is entitled to the benefit of Japanese Patent Application No.2024-154709, filed on Sep. 9, 2024, the disclosure of which including the specification, drawings and abstract is incorporated herein by reference in its entirety.

### TECHNICAL FIELD

The present disclosure relates to a prediction device, a prediction method, and a prediction program.

### BACKGROUND ART

In general, an oil check valve (hereinafter, also referred to as “OCV”) that switches a flow destination of engine oil is disposed in an oil circulation path of a vehicle. This type of oil check valve is disposed downstream of an oil cooler in the oil circulation path and is used as a switching valve for directing oil in the oil circulation path to an oil jet path that leads to an oil jet for cooling the piston of an engine (see, for example, PTL 1).

### CITATION LIST

### Patent Literature

### PTL 1

### Japanese Patent Application Laid-Open No. 2014-98345

### SUMMARY OF INVENTION

### Technical Problem

In this type of oil check valve, a resin material (for example, a polyamide-based resin) is used as a bobbin member of a solenoid coil that operates the oil check valve. Such a resin material generally deteriorates due to heat.

When the resin material in the oil check valve deteriorates, oil may leak from the oil check valve. When the damage caused by the oil seepage expands, there is a risk that the oil may leak inside and outside the vehicle, so that it is necessary to replace the oil check valve at an early stage.

However, at present, the occurrence of the oil seepage from the oil check valve can only be found by checking the actual product at an inspection center or the like, and it is difficult to predict in advance when the leakage will occur.

The present invention has been made in view of the problems, and an object of the present invention is to provide a prediction device, a prediction method, and a prediction program each capable of predicting replacement required timing of an oil check valve mounted on a vehicle.

### Solution to Problem

The present disclosure capable of achieving the above-described object is as follows:
A prediction device that predicts replacement required timing of an oil check valve provided in an oil circulation path of a vehicle, the prediction device including:

an acquisition section that acquires, from a storage section, first information related to an operation history of the oil check valve and second information related to an oil temperature history of oil in the oil circulation path; and

a calculation section that calculates an indicator related to the replacement required timing of the oil check valve based on the first information and the second information by using a classifier model that has been trained in advance.

In another respect, the present disclosure is as follows:

A prediction method of predicting replacement required timing of an oil check valve provided in an oil circulation path of a vehicle, the prediction method including:

processing of acquiring, from a storage section, first information related to an operation history of the oil check valve and second information related to an oil temperature history of oil in the oil circulation path; and

processing of calculating an indicator related to the replacement required timing of the oil check valve based on the first information and the second information by using a classifier model that has been trained in advance.

In another respect, the present disclosure is as follows:

A prediction program causing a computer to execute prediction of replacement required timing of an oil check valve provided in an oil circulation path of a vehicle, the prediction program including:

processing of acquiring, from a storage section, first information related to an operation history of the oil check valve and second information related to an oil temperature history of oil in the oil circulation path; and

processing of calculating an indicator related to the replacement required timing of the oil check valve based on the first information and the second information by using a classifier model that has been trained in advance.

### Advantageous Effects of Invention

With the prediction device according to the present invention, it is possible to predict the replacement required timing of an oil check valve mounted on a vehicle.

### BRIEF DESCRIPTION OF DRAWINGS

FIG. 1 illustrates an example of the configuration of a vehicle;

FIG. 2 illustrates an example of the overall configuration of an oil supply device;

FIG. 3 illustrates an example of the configuration of an ECU;

FIG. 4 illustrates an example of oil temperature history data of an oil circulation path;

FIG. 5 illustrates an example of operation history data of an oil check valve;

FIG. 6 illustrates the results of investigating a correlation between vehicles with replacement of oil check valve/vehicles with no replacement of oil check valve and each parameter;

FIG. 7 illustrates the results of a market survey on the frequency of replacement or non-replacement (that is, failure occurrence or failure non-occurrence) of oil check valves and types of mounting of the vehicle;

FIG. 8 illustrates an example of the configuration of a classifier model;

FIG. 9 is a flowchart illustrating an example of an operation of the ECU;

FIG. 10 is a diagram schematically describing the flowchart of FIG. 9;

FIG. 11 illustrates an example of a display screen displayed on a display section of the ECU; and

FIG. 12 illustrates an example of a transition display screen of a failure occurrence probability.

### DESCRIPTION OF EMBODIMENTS

Hereinafter, preferred embodiments of the present invention will be described in detail with reference to the accompanying drawings. In the present specification and drawings, components having substantially the same function are denoted by the same reference numeral, and a redundant description is omitted.

### <Overall Configuration of Vehicle>

Hereinafter, the configuration of a vehicle (hereinafter, referred to as a “vehicle C”) according to an embodiment of the present invention and a prediction device mounted on vehicle C will be described.

The prediction device according to the present embodiment is configured by an engine control unit (ECU) that operates an oil check valve mounted on a vehicle, and the prediction device predicts replacement required timing of the oil check valve. However, the prediction device need not be mounted on a vehicle, and may be configured by, for example, a computer for management located outside the vehicle.

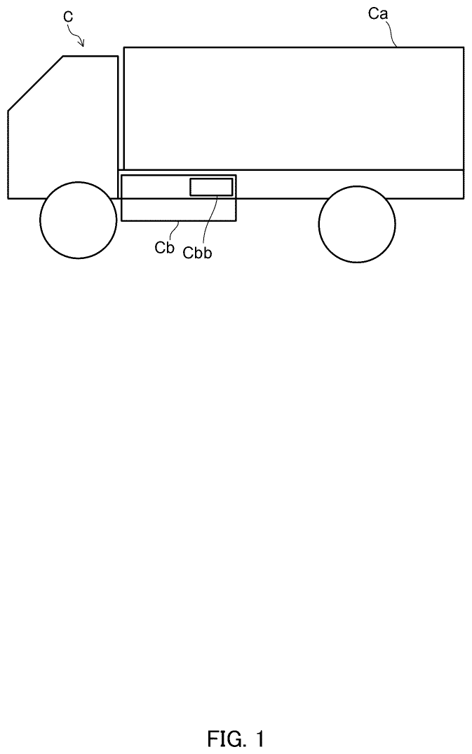

FIG. 1 illustrates an example of the configuration of vehicle C.

Vehicle C is, for example, a large-sized vehicle including mounting Ca. Vehicle C includes engine Cb and oil supply device Cbb for supplying oil for cooling the piston to engine Cb.

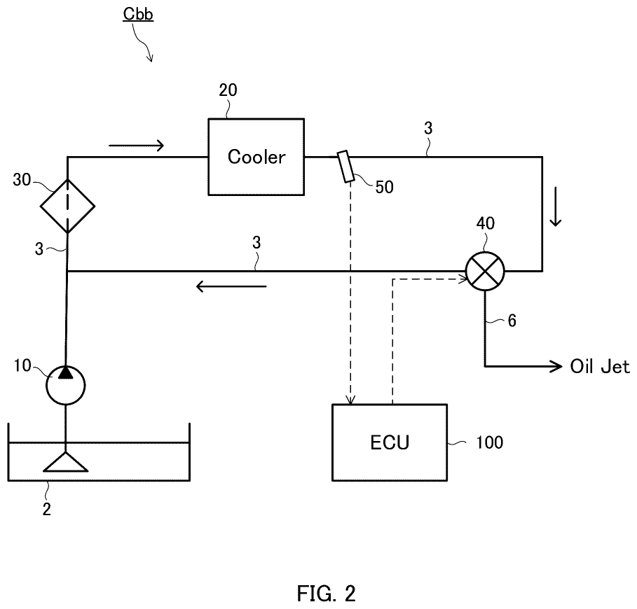

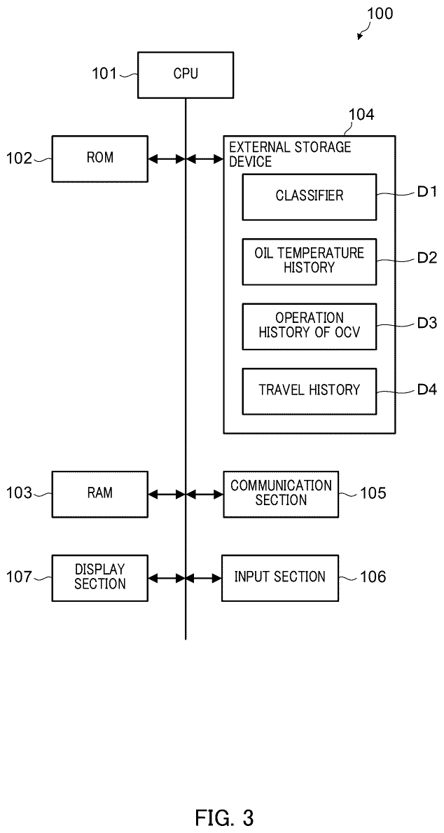

FIG. 2 illustrates an example of the overall configuration of oil supply device Cbb. FIG. 3 illustrates an example of the configuration of ECU 100.

Oil supply device Cbb includes oil pan 2, oil circulation path 3, oil jet path 6, oil pump 10, oil cooler 20, oil filter 30, oil check valve 40, oil temperature sensor 50, and ECU 100.

Oil pump 10 sucks up the oil stored in oil pan 2 and pressurizes the oil into oil circulation path 3. Oil pump 10 is, for example, a mechanical oil pump that is driven in conjunction with the rotation of a crankshaft of engine Cb.

Oil circulation path 3 is a circulation path of the oil, and circulates the oil sent out from oil pump 10. In oil circulation path 3, oil filter 30, oil cooler 20, and oil check valve 40 are disposed from the upstream side. Oil circulation path 3 is connected to oil jet path 6 at a position of oil check valve 40—oil jet path 6 is an oil path leading to an oil jet for cooling the piston of engine Cb.

Oil cooler 20 cools the oil in oil circulation path 3 and sends out the oil to oil check valve 40.

Oil check valve 40 switches a flow destination of the oil sent from oil cooler 20 between oil jet path 6 side and the return path side of oil circulation path 3. Specifically, oil check valve 40 operates a solenoid built therein in response to a control signal from ECU 100 to switch the flow destination of the oil in oil circulation path 3.

Since the configuration of oil check valve 40 is the same as a known configuration in the related art, the description thereof will be omitted in the present specification.

Oil check valve 40 includes, for example, a spool valve that is disposed in an inner space provided inside a casing and is reciprocally movable in an axial direction. Oil check valve 40 operates the spool valve by using the solenoid that is integrally disposed with the spool valve, thereby switching the flow destination of the oil in oil circulation path 3 between the oil jet path 6 side and the return path side of oil circulation path 3.

In oil check valve 40, a resin material (for example, a polyamide-based resin) is used as a bobbin material of a coil constituting the solenoid. The bobbin material also functions as a sealing material for the oil in oil check valve 40.

Oil check valve 40 is electrically connected to ECU 100 and is operated and controlled by a control current supplied from ECU 100. In this case, in a state in which the control current is not supplied to the solenoid in oil check valve 40, oil check valve 40 sends out the oil sent from oil cooler 20 to the oil jet path 6 side. Then, when the control current is supplied to the solenoid in oil check valve 40, the solenoid is driven to move the spool valve inside oil check valve 40 to one side, and the oil sent from oil cooler 20 is sent to the return path side of oil circulation path 3. That is, oil check valve 40 according to the present embodiment is controlled in such a way that the oil jet is turned off when the current is turned on (i.e., in the current ON state), and to perform the oil jet injection when the current is turned off (i.e., in the current OFF state).

Oil temperature sensor 50 is disposed in oil circulation path 3 and constantly detects the oil temperature in oil circulation path 3. In this case, oil temperature sensor 50 according to the present embodiment is disposed downstream of oil cooler 20 in oil circulation path 3 and detects the oil temperature of the oil passing through oil check valve 40. Oil temperature sensor 50 is electrically connected to ECU 100 and transmits the detected oil temperature to ECU 100.

ECU 100 is a computer including, for example, as main components, CPU 101, ROM 102, RAM 103, external storage device (for example, a flash memory) 104, communication section (for example, a communication module connected to the Internet) 105, input section (for example, a keyboard or a mouse) 106, display section (for example, a liquid crystal display) 107, and the like.

Functions of ECU 100 described below are realized, for example, by CPU 101 referring to a processing program and various types of data stored in ROM 102, RAM 103, external storage device 104, and the like. The processing executed by CPU 101 corresponds to functions as an “acquisition section” and a “calculation section” according to the embodiment of the present invention.

External storage device 104 stores data D1 of a classifier model that has been trained in advance, oil temperature history data D2 of oil circulation path 3, operation history data D3 of oil check valve 40, and travel history data D4 of vehicle C.

In this case, oil temperature history data D2 of oil circulation path 3, operation history data D3 of oil check valve 40, and travel history data D4 of vehicle C are data that are sequentially stored in external storage device 104 when vehicle C is traveling. In addition, data D1 of the trained classifier model is, for example, a classifier model that has been trained in advance through a learning process and that has adjusted parameters (details will be described below).

<Basic Concept of Prediction of Replacement required timing of Oil Check Valve>

ECU 100 according to the present embodiment has a function of predicting the replacement required timing of oil check valve 40 (that is, predicting when oil check valve 40 needs to be replaced). First, a basic concept of a method of predicting the replacement required timing of oil check valve 40 by ECU 100 according to the present embodiment will be described.

The inventors of the present invention have recognized the importance of quantifying the thermal damage to the bobbin material of oil check valve 40 in order to accurately predict the replacement required timing of oil check valve 40, and have studied influencing factors that cause the thermal damage to the bobbin material. This is because the oil seepage from the bobbin material is mainly caused by thermal deterioration of the resin material constituting the bobbin material.

As the results, it was found that the thermal damage to the bobbin material of oil check valve 40 is composed of (1) thermal damage due to an atmosphere temperature around the bobbin material and (2) thermal damage due to a coil wire.

Specifically, (1) the thermal damage due to the atmosphere temperature around the bobbin material is thermal damage caused by an increase in the atmosphere temperature due to the oil temperature of the oil in oil circulation path 3 in which oil check valve 40 is used. In oil check valve 40, the bobbin material is disposed in close proximity to the oil in oil circulation path 3, and therefore the atmosphere temperature around the bobbin material rises to approximately the oil temperature of the oil. Such an atmosphere temperature around the bobbin material causes thermal deterioration of the bobbin material to proceed at a temperature at that time.

The total amount of the thermal damage that the bobbin material receives due to such an atmosphere temperature (hereinafter, referred to as a “total amount of the thermal damage”) can be quantified from the occurrence frequency for respective oil temperatures of the oil in oil circulation path 3 from a start of use of oil check valve 40 until the reference time for thermal damage determination.

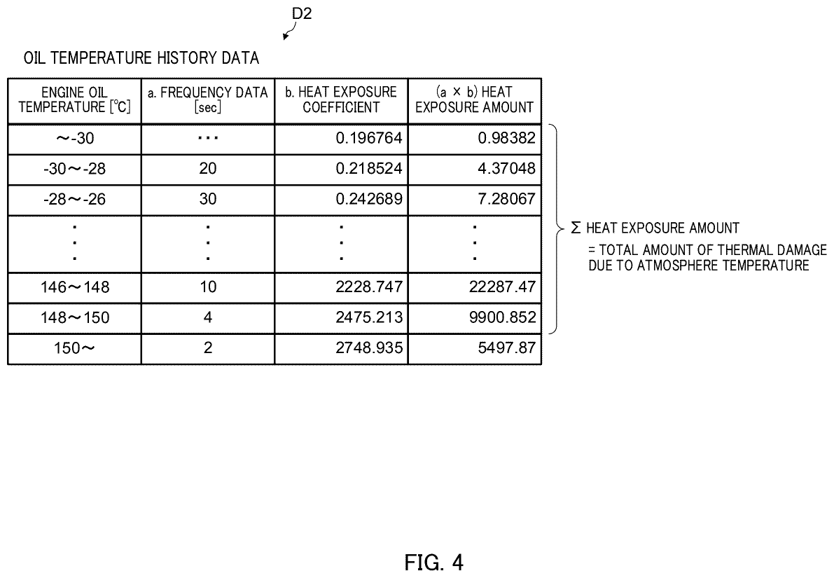

FIG. 4 illustrates an example of oil temperature history data D2 of oil circulation path 3. In actual case, oil temperature history data D2 is time-series temperature data that is constantly acquired from oil temperature sensor 50. FIG. 4 illustrates data in which the time-series temperature data is organized into the occurrence frequencies for respective oil temperatures from the start of use of oil check valve 40 (for example, when vehicle C is delivered) to the present time.

As illustrated in FIG. 4, ECU 100 according to the present embodiment calculates the occurrence frequency for each oil temperature of the oil in oil circulation path 3 from the time-series temperature data (oil temperature history data D2) constantly acquired from oil temperature sensor 50, and thus derives the total amount of the thermal damage received by the bobbin material due to the atmosphere temperature.

In this case, a speed of the thermal deterioration of a component generally depends on the atmosphere temperature around the component. Such a speed of thermal deterioration can be derived by the Arrhenius equation. From such a viewpoint, for more accurately calculating the total amount of the thermal damage received by the bobbin material due to the atmosphere temperature, ECU 100 according to the present embodiment converts the oil temperature into “b. heat exposure coefficient” by using the Arrhenius equation, calculates a heat exposure amount (that is, a thermal damage amount) for each oil temperature by multiplying “a. frequency” of the oil temperature by the “b. heat exposure coefficient” (a×b), and derives the total amount of the thermal damage as the total heat exposure amount by adding up the obtained values. Then, the total amount of the thermal damage is used as an explanatory variable to be input to the classifier model described below. In the present embodiment, for the polyamide-based resin, which is the bobbin material of oil check valve 40, the oil temperature was converted to “b. heat exposure coefficient” by the Arrhenius equation.

(2) The thermal damage due to the coil wire is thermal damage caused by heat generation of the solenoid coil wound and fixed around the bobbin material of oil check valve 40. Oil check valve 40 is operated each time a flow path of oil circulation path 3 is switched. The solenoid coil in oil check valve 40 generates heat because of the current flowing through the solenoid coil each time. Such heat generated by the solenoid coil directly heats the bobbin material, causing thermal damage to the bobbin material.

Therefore, the degree of thermal damage to the bobbin material depends on a heat generation time of the solenoid coil, that is, an operation time of oil check valve 40. In addition, the degree of heat generation of the solenoid coil is largest when the current state is switched from the current OFF state to the current ON state, and therefore the degree of heat generation of the solenoid coil is also correlated with the number of operations of oil check valve 40 (that is, number of times oil check valve 40 is operated).

That is, the total amount of thermal damage received by the bobbin material due to the heat generation of such a coil wire can be quantified from the total operation time and the total number of operations of oil check valve 40 from the start of use of oil check valve 40 until the reference time for thermal damage determination.

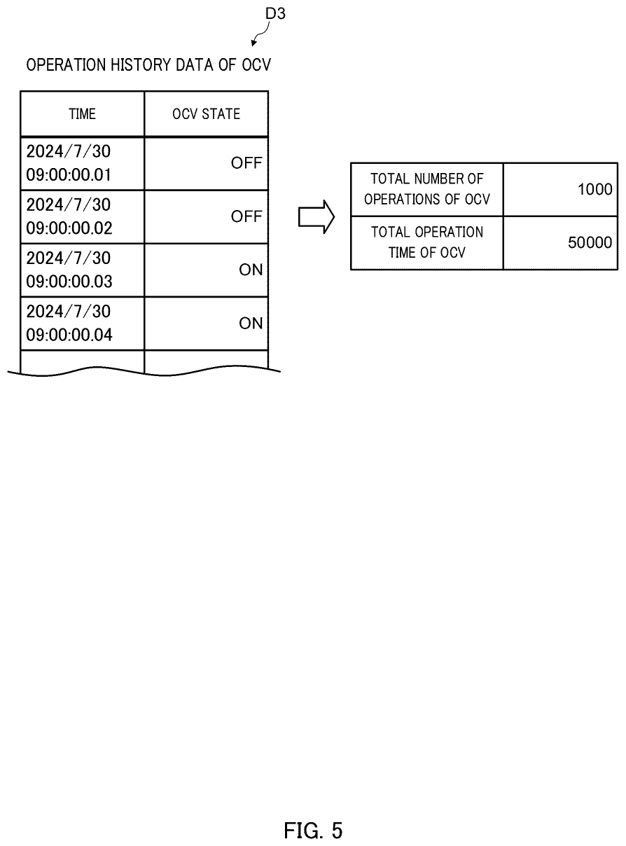

FIG. 5 illustrates an example of operation history data D3 of oil check valve 40. Operation history data D3 is time-series data related to ON/OFF of oil check valve 40. Oil check valve 40 according to the present embodiment is in the current ON state when the oil jet is in an OFF state (for example, during idling), and is in the current OFF state when the he oil jet is being injected (for example, while the vehicle is traveling).

As illustrated in FIG. 5, ECU 100 according to the present embodiment calculates the total operation time and the total number of operations from the start of use of oil check valve 40 (for example, when vehicle C is delivered) to the present time from the time-series data related to the ON/OFF of oil check valve 40, and uses the values as a reference for the total amount of the thermal damage caused to the bobbin material by the coil wire. That is, ECU 100 according to the present embodiment uses the operation frequency (total operation time and total number of operations) of oil check valve 40 as an explanatory variable input to the classifier model described below.

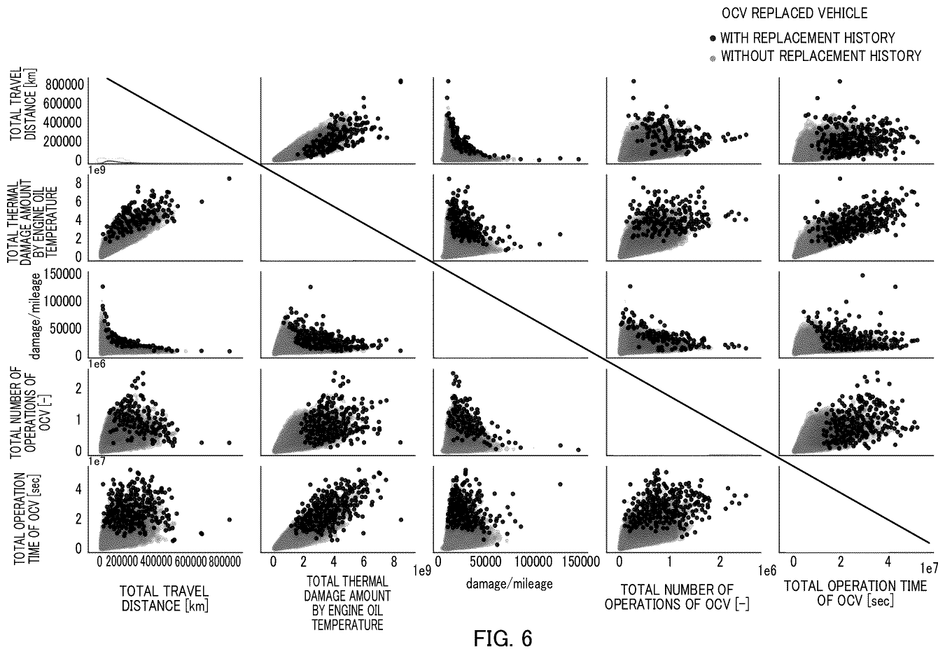

FIG. 6 illustrates the results of a market survey on the correlation between vehicles with replacement of oil check valve/vehicles with no replacement of oil check valve and various parameters. In this survey, the extent to which it was possible to distinguish between the vehicles with replacement of oil check valve and the vehicles with no replacement of oil check valve was confirmed using various parameters. In each diagram of FIG. 6, two variables of various parameters are taken, and a correlation between the magnitude of each parameter and the vehicles with replacement of oil check valve/vehicles with no replacement of oil check valve is confirmed. The “damage/mileage” in FIG. 6 is a value obtained by dividing the total amount of the thermal damage due to the atmosphere temperature by the total travel distance.

From FIG. 6 shows that the total amount of the thermal damage due to the atmosphere temperature, the total operation time of the oil check valve, and the total number of operations of the oil check valve are strongly correlated with the replacement or non-replacement of the oil check valve (that is, failure occurrence or failure non-occurrence).

In addition, FIG. 6 shows that the total travel distance of the vehicle is also strongly correlated with the replacement or non-replacement of the oil check valve (that is, failure occurrence or failure non-occurrence).

In addition, the inventors of the present invention have found that there is a strong correlation between the frequency of replacement or non-replacement of the oil check valve (that is, failure occurrence or failure non-occurrence) and the type of vehicle, particularly the type of mounting the vehicle is provided, as a further requirement.

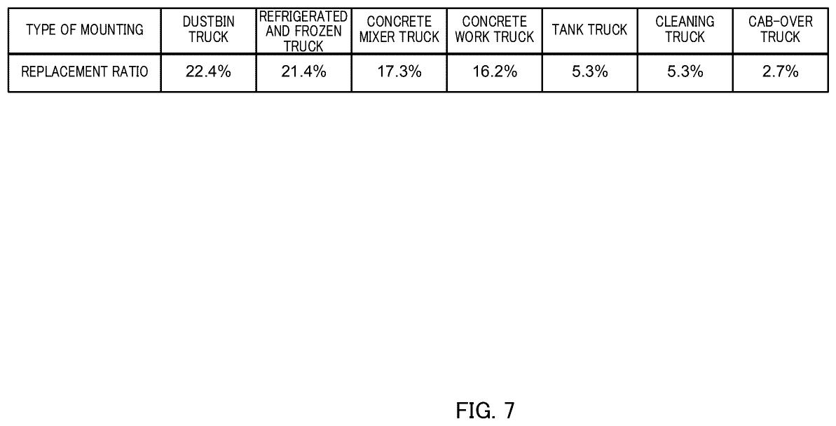

FIG. 7 illustrates the results of a market survey on the frequency of replacement or non-replacement of the oil check valve (that is, failure occurrence or failure non-occurrence) and the type of mounting of the vehicle. The replacement ratio in FIG. 7 represents the ratio of replacement or non-replacement of the oil check valve of various vehicles after a predetermined time has elapsed from the time point at which the oil check valve starts to be used (herein, after three and a half years have elapsed).

As can be seen from FIG. 7, in a vehicle that frequently repeats stopping and starting, such as a dustbin truck (that is, a garbage collection truck), the deterioration of the oil check valve is relatively fast. This is because, in such a vehicle, the engine is more likely to be overheated and the oil temperature of the oil in oil circulation path 3 is more likely to be increased due to frequent repetition of stopping and starting. In addition, this is because, in such a vehicle, the degree of heat generation of the coil of the oil check valve is also increased due to frequent repetition of stopping and starting.

In addition, as the results of the market survey, it has been found that the time at which it is determined that the replacement of the oil check valve is required also changes depending on the vehicle type. For example, because the way a refrigerated truck is used does not permit oil to seep out to the outside, when deterioration is observed in the appearance of the oil check valve, the oil check valve is replaced at an early stage before the oil seepage from the oil check valve is found. That is, it can be said that, for predicting the replacement required timing of the oil check valve and informing the user of the replacement required timing, it is essential to distinguish the replacement required timing between different vehicle types.

Examples of the type of mounting to be mounted on the vehicle include a dustbin truck, a refrigerated and frozen truck, a concrete mixer truck, a concrete work truck, a tank truck, a cleaning truck, and a cab-over truck.

As described above, the replacement required timing of oil check valve 40 greatly depends on (1) the total amount of the thermal damage of oil check valve 40 due to the atmosphere temperature around the bobbin material and (2) the total amount of the thermal damage of oil check valve 40 due to the coil wire. That is, it is possible to predict the replacement required timing of oil check valve 40 by using these pieces of information as explanatory variables and constructing a classifier model through machine learning based on the training data obtained in the market.

In addition, in this case, it is suggested that the prediction accuracy can be further improved by adding the total travel distance of vehicle C from the start of use of oil check valve 40 and the type of mounting mounted on vehicle C as supplementary factors to the explanatory variables.

Although the total amount of the thermal damage due to the atmosphere temperature around the bobbin material, the total amount of the thermal damage due to the heat generation of the coil wire, and the total travel distance of vehicle C overlap with each other in terms of the total amount of the thermal damage to the bobbin material, these elements can be captured as individual feature amounts in the classifier model obtained by the machine learning. Moreover, during the processing of the learning process, the classifier model can adjust the degree of influence of these elements on the ultimate need for replacement of the oil check valve (that is, the failure occurrence probability).

In the present embodiment, a neural network capable of handling a large amount of data and good at solving a non-linear classification problem is adopted as classifier model D1.

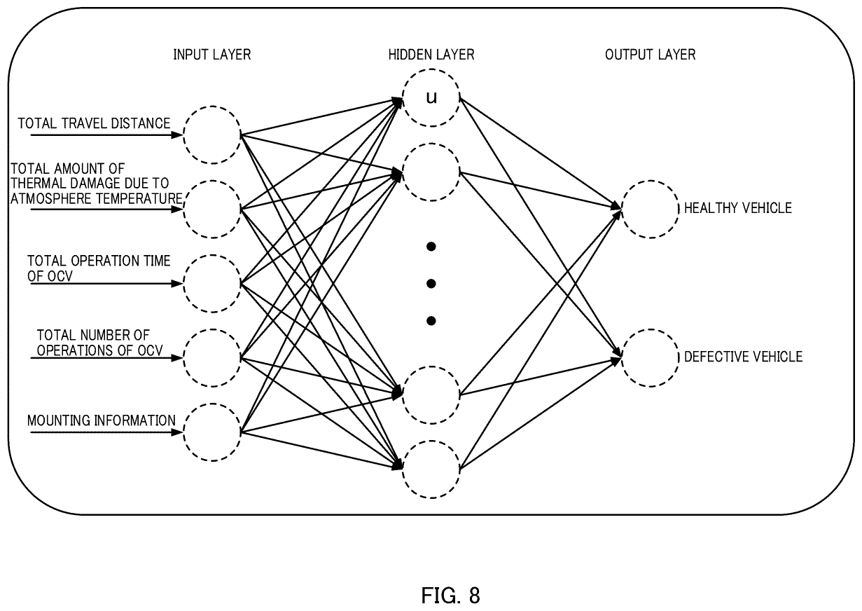

FIG. 8 illustrates an example of the configuration of classifier model D1.

On the basis of the elements, classifier model D1 according to the present embodiment calculates a failure occurrence probability of oil check valve 40 at a predetermined determination reference time in order to predict the replacement required timing of oil check valve 40 (for example, the time point at which the failure of oil check valve 40 occurs).

Specifically, classifier model D1 according to the present embodiment uses, as explanatory variables, (a) the total travel distance of vehicle C, (b) the total operation time of oil check valve 40, (c) the total number of operations of oil check valve 40, (d) the total amount of the thermal damage due to the atmosphere temperature caused by the oil temperature of the oil in oil circulation path 3, and (e) the type of mounting of vehicle C. That is, the classifier model according to the present embodiment includes, in an input layer, input elements for inputting these items. The elements of (a) to (d) have total values from the start of use of oil check valve 40 until the determination reference time as input values.

Moreover, classifier model D1 according to the present embodiment includes, in an output layer, an output element that outputs the failure occurrence probability at the predetermined determination reference time from the time point at which oil check valve 40 starts to be used. That is, classifier model D1 according to the present embodiment outputs the failure occurrence probability at the predetermined determination reference time as an indicator related to the replacement required timing of the oil check valve.

In classifier model D1 according to the present embodiment, the number of layers of an intermediate layer is set to one from the viewpoint of reducing a calculation load. In addition, a Relu function is used as an activation function of the intermediate layer, and a sigmoid function is used as an activation function of the output layer.

Classifier model D1 has undergone a learning process in advance based on the training data collected in the market. The training data is a data set in which the history data of (a) to (e) stored in a storage section or the like of each vehicle is associated with correct answer data related to whether the oil check valve of the vehicle has been replaced or not. As the training data, data obtained by performing undersampling such that the ratio of the number of defective vehicles to the number of healthy vehicles is 1:1 is used. In this case, the definition of the defective vehicle is a vehicle in which the oil check valve is replaced.

In the learning process, the history data of (a) to (e) of the training data is input from the input layer, and the output layer outputs whether the vehicle is healthy or defective. Then, whether the result is correct or incorrect is taught, and the network parameters (that is, the weight coefficient and the bias) are updated. Specifically, for example, an error (that is, a loss function) between a correct answer (here, 1 or 0) and an output value is taken, and the error is propagated from the output layer to each layer by an error backpropagation method, and the network parameters (that is, the weight coefficient and the bias) are adjusted so as to approach the correct answer value.

The data of the trained classifier model D1 that has been subjected to the training process in this manner is stored in external storage device 104 of vehicle C. That is, in this case, external storage device 104 stores model data related to the input layer, the intermediate layer, and the output layer of the neural network, and the network parameters (that is, the weight coefficient and the bias) adjusted by the learning process.

<Specific Processing of Prediction of Replacement required timing of Oil Check Valve>
Next, specific processing of predicting the replacement required timing of oil check valve 40 by ECU 100 according to the present embodiment will be described.

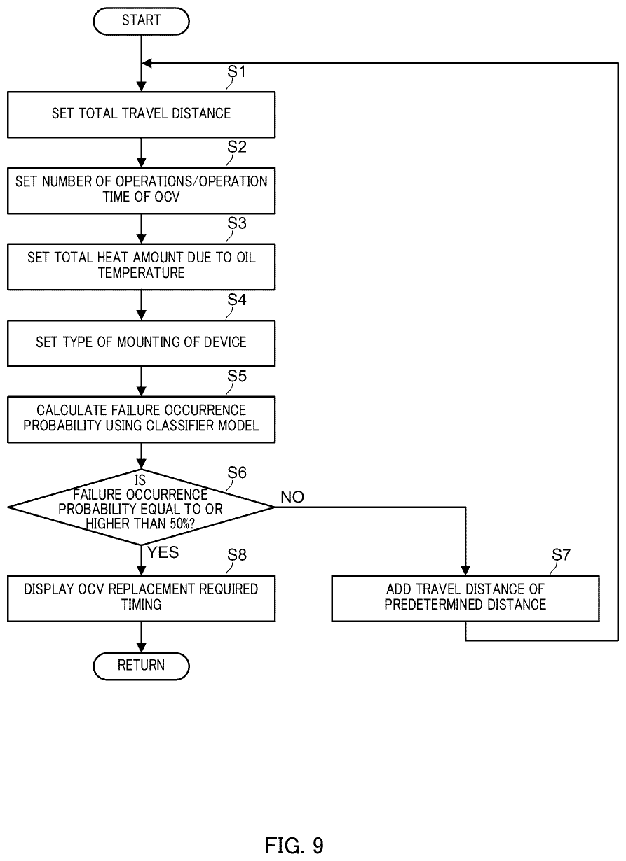

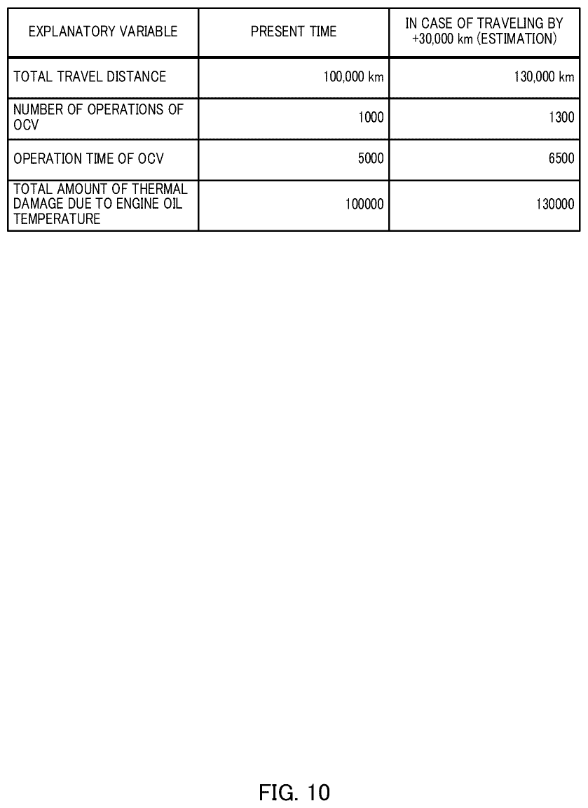

FIG. 9 is a flowchart illustrating an example of an operation of ECU 100. FIG. 10 is a diagram schematically describing the flowchart of FIG. 9.

A basic concept of the flowchart of FIG. 9 is as follows.

On the basis of oil temperature history data D2 of the oil in oil circulation path 3, ECU 100 according to the present embodiment estimates the total amount of the thermal damage of oil check valve 40 accompanied by the increase in the atmosphere temperature due to the oil temperature of the oil from the time point at which oil check valve 40 starts to be used to a future determination reference time (“future determination reference time” means a reference time point for determining the failure occurrence probability of oil check valve 40; hereinafter the same definition is applied). In addition, ECU 100 estimates the operation frequency (that is, the total amount of the thermal damage of oil check valve 40) of oil check valve 40 from the time point at which oil check valve 40 starts to be used to the future determination reference time based on operation history data D3 of oil check valve 40. In addition, ECU 100 estimates the total travel distance of vehicle C from the time point at which oil check valve 40 starts to be used to the future determination reference time based on travel history data D4 of vehicle C.

This estimation calculation may be performed, for example, by using the ratio of a time from the time point at which oil check valve 40 starts to be used to the present time to a time from the time point at which oil check valve 40 starts to be used to the future determination reference time (here, the ratio between the total travel distances), as illustrated in FIG. 10. ECU 100 estimates each total value from the time point at which oil check valve 40 starts to be used to the future determination reference time by increasing the corresponding total value from the time point at which oil check valve 40 starts to be used to the present time by, for example, a time ratio.

FIG. 10 illustrates an example of each estimated value at a future time point (hereinafter, “+30,000 km time point”) at which vehicle C further travels +30,000 km when the total travel distance of vehicle C at the present time point is 100,000 km. In this case, each estimated value at the +30,000 km time point is calculated as a value 1.3 times (=130,000 km/100,000 km) the value indicated by the history at the present time point in accordance with the ratio between the total travel distances. In FIG. 10, for example, the total number of operations of oil check valve 40 at the +30,000 km time point is estimated as 1,300 times (1,000 times ×1.3), the total operation time of oil check valve 40 at the +30,000 km time point is estimated as 6,500 hours (5,000 hours ×1.3), and the total amount of the thermal damage due to the oil temperature at the +30,000 km time point is estimated as 130,000 (100,000×1.3).

Then, ECU 100 calculates the failure occurrence probability of oil check valve 40 at the future determination reference time by using the trained classifier model D1 based on these elements.

Moreover, ECU 100 calculates the failure occurrence probability at each of time points by time-evolving the future determination reference time, and indicates a time point (among the time points) at which the failure occurrence probability exceeds a predetermined value (here, 50%) as the replacement required timing of oil check valve 40. In the present embodiment, the total travel distance of vehicle C is used as the reference time point.

Hereinafter, the flowchart of FIG. 9 will be specifically described.

In step S1, ECU 100 acquires the total travel distance of vehicle C from travel history data D4 stored in external storage device 104 and sets the total travel distance as an input value of classifier model D1.

In step S1, the total travel distance of vehicle C set as the input value of classifier model D1 is the total travel distance of vehicle C from the start of use of oil check valve 40 to the future determination reference time; however, in the first loop processing, the total travel distance of vehicle C from the start of use of oil check valve 40 to the present time is provisionally set as the input value.

In step S2, ECU 100 acquires the total number of operations and the total operation time of oil check valve 40 from operation history data D3 of oil check valve 40 stored in external storage device 104 and sets the total number of operations and the total operation time as input values of classifier model D1. In this case, as described with reference to FIG. 5, ECU 100 acquires the total operation time and the total number of operations from the start of use of oil check valve 40 (for example, when vehicle C is delivered) to the present time from the time-series data (operation history data D3) related to the ON/OFF of oil check valve 40.

In step S2, the total number of operations and the total operation time of oil check valve 40 set as the input values of classifier model D1 are the total number of operations and the total operation time of oil check valve 40 from the start of use of oil check valve 40 to the future determination reference time; however, in the first loop processing, the total number of operations and the total operation time of oil check valve 40 from the start of use of oil check valve 40 to the present time are provisionally set as the input values.

In step S3, ECU 100 acquires the total amount of the thermal damage of oil check valve 40 due to the oil temperature (atmosphere temperature) of oil circulation path 3 from oil temperature history data D2 of the oil in oil circulation path 3 stored in external storage device 104, and sets the total amount of the thermal damage as an input value of classifier model D1. In this case, as described with reference to FIG. 4, ECU 100 calculates the occurrence frequency for each oil temperature of the oil in oil circulation path 3 from the time-series temperature data (oil temperature history data D2) which is constantly acquired from oil temperature sensor 50. Then, ECU 100 calculates the thermal damage amount for each oil temperature by multiplying “a. frequency” by “b. heat exposure coefficient” obtained by converting the oil temperature by the Arrhenius equation (a×b), and calculates the total amount of the thermal damage of oil check valve 40 by adding up the values.

In step S3, the total amount of the thermal damage due to the oil temperature (atmosphere temperature) of oil circulation path 3 set as the input value of classifier model D1 is the total amount of the thermal damage due to the oil temperature (atmosphere temperature) of oil circulation path 3 from the start of use of oil check valve 40 to the future determination reference time; however, in the first loop processing, the total amount of the thermal damage due to the oil temperature (atmosphere temperature) of oil circulation path 3 from the start of use of oil check valve 40 to the present time is provisionally set as the input value.

In step S4, ECU 100 acquires the type of mounting of vehicle C, and sets the type of mounting of vehicle C as an input value of the trained classifier model D1. In this case, for example, any one of a dustbin truck, a refrigerated and frozen truck, a concrete mixer truck, a concrete work truck, a tank truck, a cleaning truck, and a cab-over truck is selected as the type of mounting of vehicle C and input by the user.

In step S5, ECU 100 calculates the failure occurrence probability of oil check valve 40 at the determination reference time (however, the present time in the first loop) by using the trained classifier model D1 based on the input values set in steps S1 to S4. Specifically, ECU 100 calculates the failure occurrence probability of oil check valve 40 by forward propagation processing of the trained classifier model D1 based on the input values set in steps S1 to S4.

In step S6, ECU 100 determines whether or not the failure occurrence probability of oil check valve 40 is equal to or higher than a threshold value (for example, 50%). When the failure occurrence probability of oil check valve 40 is lower than the threshold value (S6: NO), ECU 100 proceeds to step S7.

In step S7, ECU 100 adds a travel distance of a predetermined distance (here, +30,000 km) to the total travel distance of vehicle C, and updates the data having been set as the input values of the trained classifier model D1 in steps S1 to S3.

In step S7, as described with reference to FIG. 10, ECU 100 adds +30,000 km to the total travel distance of vehicle C and calculates the total number of operations of oil check valve 40 at the +30,000 km time point, the total operation time of oil check valve 40 at the +30,000 km time point, and the total amount of the thermal damage due to the oil temperature at the +30,000 km time point.

After step S7, ECU 100 returns to step S1 and sets the calculated values at the +30,000 km time point as the input values of the trained classifier model D1 (S1, S2, S3). Then, ECU 100 calculates the failure occurrence probability of oil check valve 40 again in step S5, and determines in step S6 whether or not the failure occurrence probability becomes equal to or higher than the threshold value (for example, 50%).

In this way, ECU 100 repeats the loop processing of steps S1 to S7 until the failure occurrence probability of oil check valve 40 becomes equal to or higher than the threshold value (that is, repeats adding +30,000 km to the total travel distance of vehicle C). When the failure occurrence probability becomes equal to or higher than the threshold value (for example, 50%) in step S6 (S6: YES), ECU 100 proceeds to step S8.

In step S8, ECU 100 displays the time point at which the failure occurrence probability of oil check valve 40 becomes equal to or higher than the threshold value (in this case, the total travel distance of vehicle C when the failure occurrence probability of oil check valve 40 becomes equal to or higher than the threshold value) on display section 107 as the replacement required timing of oil check valve 40.

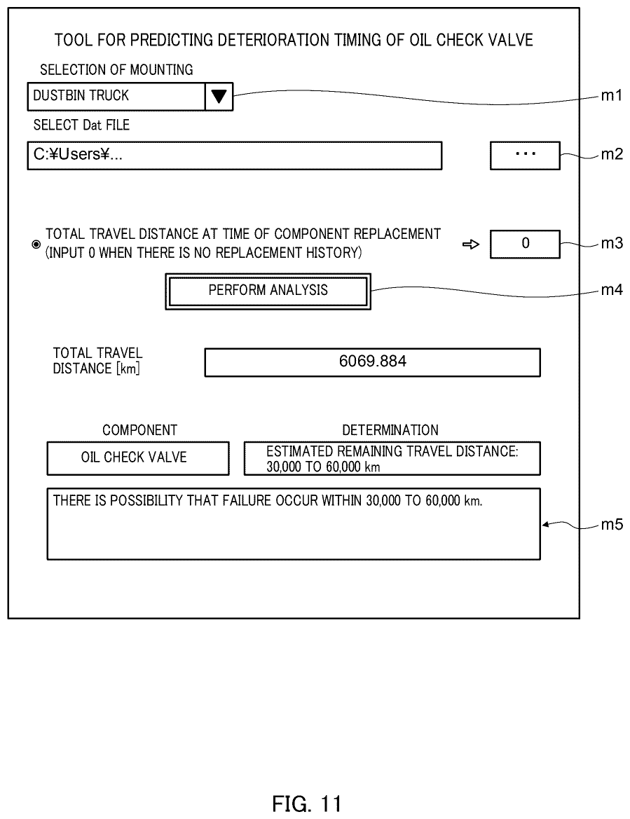

FIG. 11 illustrates an example of a display screen displayed on display section 107 of ECU 100.

The display screen according to the present embodiment includes input reception section m1 that receives the selection input of the type of mounting of vehicle C of the user, input reception section m2 that receives the selection input of data (that is, the history data D2, D3, and D4) to be read out from external storage device 104, and input reception section m3 that receives the input of the total travel distance at the time of the last replacement of oil check valve 40.

Moreover, when the items are input by the user and then analysis execution start button m4 on the display screen is selected, ECU 100 executes the processing of the flowchart of FIG. 9. Then, ECU 100 displays the replacement required timing of oil check valve 40 calculated in the processing of the flowchart of FIG. 9 in analysis result display region m5 of the display screen.

### Effect

As described above, the prediction device that predicts the replacement required timing of an oil check valve according to the present embodiment includes the following:

an acquisition section that acquires, from a storage section, first information related to an operation history of the oil check valve and second information related to an oil temperature history of oil in an oil circulation path, and

a calculation section that calculates an indicator related to the replacement required timing of the oil check valve based on the first information and the second information by using a classifier model that has been trained in advance.

With the prediction device according to the present embodiment, it is possible to propose the replacement required timing of an oil check valve in advance. As the results, it is possible to perform the component replacement before the failure of the oil check valve, and thus it is possible to prevent the sudden failure of the oil check valve.

In addition, in the prediction device according to the present embodiment, in particular, it is possible to predict the replacement required timing of an oil check valve by a simple classifier model using a neural network. This is useful in that it is possible to perform the prediction calculation without a calculation load.

### (Variation 1)

In the above-described embodiment, the aspect has been described in which only a single time point (total travel distance of vehicle C) at which the failure occurrence probability of oil check valve 40 becomes equal to or higher than the threshold value is displayed as the replacement required timing of oil check valve 40; however, it may be convenient for the user to know the transition of the failure occurrence probability of oil check valve 40 at time points in the future.

From such a viewpoint, ECU 100 may display the transition of the failure occurrence probability of oil check valve 40 at time points in the future on display section 107. ECU 100 displays, for example, the transition of the failure occurrence probability of oil check valve 40 according to the elapsed time from the present time point.

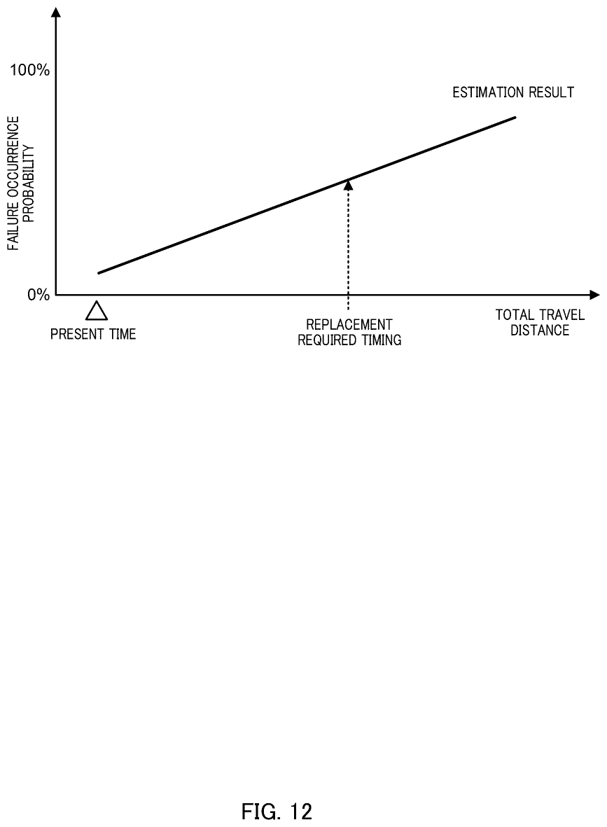

FIG. 12 illustrates an example of a transition display screen of the failure occurrence probability. When such a variation is implemented, it is desirable to set the travel distance to be added to the total travel distance of vehicle C to be short in the processing of step S7 of the flowchart of FIG. 9. As the results, it is possible to reduce the interval between the plotted points of the transition of the failure occurrence probability of oil check valve 40 at the time points in the future.

### (Variation 2)

In the above-described embodiment, a neural network is shown as an example of classifier model D1, but another model may be used as classifier model D1. For example, as classifier model D1, a support vector machine (SVM) or a Bayesian classifier may be used, or an ensemble model may be used. In addition, the classifier model may be configured by combining a plurality of types of classifiers.

### (Variation 3)

In the above-described embodiment, for estimating the total amount of the thermal damage of oil check valve 40 due to the atmosphere temperature increase caused by the oil temperature of the oil from the time point at which oil check valve 40 starts to be used to the future determination reference time based on oil temperature history data D2 of the oil in oil circulation path 3, the ratio of the time from the time point at which oil check valve 40 starts to be used to the present time to the time from the time point at which oil check valve 40 starts to be used to the future determination reference time (in the above description, the ratio between the total travel distances) is used. However, the estimation calculation can be adjusted in various ways. For example, when a usage frequency of vehicle C or the oil temperature occurrence frequency of the oil varies depending on the season, a calculation expression considering such a variation may be used.

Although the specific examples of the present invention have been described in detail above, the specific examples are merely examples and do not limit the scope of the claims. The technology described in the claims includes various modifications and variations of the specific examples illustrated above.

### INDUSTRIAL APPLICABILITY

With the prediction device according to the aspect of the present invention, it is possible to predict the replacement required timing of an oil check valve mounted on a vehicle.

1. A prediction device that predicts replacement required timing of an oil check valve provided in an oil circulation path of a vehicle, the prediction device comprising:
an acquisition section that acquires, from a storage section, first information related to an operation history of the oil check valve and second information related to an oil temperature history of oil in the oil circulation path; and
a calculation section that calculates an indicator related to the replacement required timing of the oil check valve based on the first information and the second information by using a classifier model that has been trained in advance.

2. The prediction device according to claim 1, wherein
the calculation section estimates, based on the first information, an operation frequency of the oil check valve from a time point at which the oil check valve starts to be used to a predetermined time point in future, estimates, based on the second information, an oil temperature occurrence frequency of the oil from the time point at which the oil check valve starts to be used to the predetermined time point in the future, and calculates the indicator at the predetermined time point in the future by inputting values of the operation frequency of the oil check valve and the oil temperature occurrence frequency of the oil to the trained classifier model.

3. The prediction device according to claim 2, wherein
the calculation section calculates the indicator at each of time points in the future by time-evolving the predetermined time point in the future, and indicates, as the replacement required timing of the oil check valve, a time point at which the indicator exceeds a predetermined value, the time point being one of the time points.

4. The prediction device according to claim 1, wherein:
the acquisition section further acquires third information related to a type of mounting of the vehicle; and
the calculation section calculates the indicator based on the first information, the second information, and the third information by using the trained classifier model.

5. The prediction device according to claim 1, wherein:
the acquisition section further acquires fourth information related to a travel history of the vehicle from the storage section; and
the calculation section calculates the indicator based on the first information, the second information, and the fourth information by using the trained classifier model.

6. The prediction device according to claim 1, wherein
the first information related to the operation history of the oil check valve includes information related to a total number of operations of the oil check valve and a total operation time of the oil check valve.

7. The prediction device according to claim 1, wherein
the second information related to the oil temperature history of the oil includes information related to an occurrence frequency for respective oil temperatures of the oil.

8. The prediction device according to claim 7, wherein:
each of the oil temperatures is converted by an Arrhenius equation into a heat exposure coefficient of a bobbin material in the oil check valve, the heat exposure coefficient depending on the oil temperatures; and
the oil temperature history is referred to as information indicating a total amount of thermal damage of the bobbin material, the thermal damage being calculated based on the occurrence frequency for each of the oil temperatures and the heat exposure coefficient.

9. The prediction device according to claim 1, wherein
the trained classifier model is configured by a neural network.

10. The prediction device according to claim 1, wherein
the indicator is a failure occurrence probability of the oil check valve.

11. The prediction device according to claim 1, wherein
the calculation section displays a transition of the indicator of the oil check valve according to an elapsed time from a present time point.

12. A prediction method for predicting replacement required timing of an oil check valve provided in an oil circulation path of a vehicle, the prediction method comprising:
processing of acquiring, from a storage section, first information related to an operation history of the oil check valve and second information related to an oil temperature history of oil in the oil circulation path; and
processing of calculating an indicator related to the replacement required timing of the oil check valve based on the first information and the second information by using a classifier model that has been trained in advance.

13. A prediction program causing a computer to execute prediction of replacement required timing of an oil check valve provided in an oil circulation path of a vehicle, the prediction program comprising:
processing of acquiring, from a storage section, first information related to an operation history of the oil check valve and second information related to an oil temperature history of oil in the oil circulation path; and
processing of calculating an indicator related to the replacement required timing of the oil check valve based on the first information and the second information by using a classifier model that has been trained in advance.
